(19) United States
(12) Patent Application Publication
(10) Pub. No.: US 2016/0056528 A1
(43) Pub. Date: Feb. 25, 2016

(54) MOBILE DEVICE

(71) Applicant: SHARP KABUSHIKI KAISHA, Osaka-shi, Osaka (JP)

(72) Inventors: Tetsuya YAMASHITA, Osaka-shi (JP); Kohichi MUROTA, Osaka-shi (JP); Keijiroh HIGASHI, Osaka-shi (JP)

(21) Appl. No.: 14/778,728

(22) PCT Filed: Jan. 21, 2014
(86) PCT No.: PCT/JP2014/051056

§ 371 Date: Sep. 21, 2015

(30) Foreign Application Priority Data
Mar. 22, 2013 (JP) 2013-060207

(51) Int. Cl. H01Q 1/24

(52) U.S. Cl. CPC H01Q 1/243

(57) ABSTRACT

A mobile phone includes an antenna housing made of a resin, an insert metal plate being insert molded into the antenna housing and having a connecting portion exposed from an outer surface of the antenna housing, and a thin film-shaped antenna element being provided on the outer surface of the antenna housing and brought into contact with the connecting portion. The mobile device having this structure provides excellent waterproof performance.

### TECHNICAL FIELD

This invention generally relates to a mobile device, and more specifically to a mobile device with an antenna on an outer portion of a housing.

### BACKGROUND ART

With regard to a conventional mobile device, Japanese Patent Laying-Open No. 2007-288360, for example, discloses a mobile communication terminal aimed at realizing simple and low-cost integration of a housing and an antenna to enable an even greater size reduction in the terminal, and increasing the degree of freedom of shape of the terminal housing (PTD 1). The mobile communication terminal disclosed in PTD 1 has an antenna element made of a conductive metal pattern formed on the surface of an outer cover of the housing.

### CITATION LIST

### Patent Document

PTD 1: Japanese Patent Laying-Open No. 2007-288360

### SUMMARY OF INVENTION

### Technical Problem

In recent years, mobile devices such as mobile phones and the like are required to be waterproof. In order to provide a waterproof structure, an antenna may be disposed inside a housing having a waterproof structure. For maximum antenna performance, however, the antenna is preferably disposed outside the housing. However, the formation of the antenna on an outer surface of a resin-molded housing leads to unevenness of the mating surfaces of housings due to a conductive member connecting between the antenna and a substrate inside the housing. This makes it difficult to establish a waterproof structure for the housing.

Accordingly, it is an object of this invention to solve the above-described problem, and provide a mobile device having excellent waterproof performance.

### Solution to Problem

A mobile device according to this invention includes a housing made of a resin, a conductive member being insert molded into the housing and having a connecting portion exposed from an outer surface of the housing, and a thin film-shaped antenna element being provided on the outer surface of the housing and brought into contact with the connecting portion.

In such a mobile device having this structure, since the conductive member is insert molded into the housing made of a resin, excellent waterproof performance can be achieved.

### Advantageous Effects of Invention

As described above, according to this invention, a mobile device having excellent waterproof performance is provided.

### BRIEF DESCRIPTION OF DRAWINGS

FIG. 1 is a front view showing the appearance of a mobile phone according to a first embodiment of this invention.

FIG. 2 is a cross-sectional view showing the mobile phone along line II-II shown in FIG. 1.

FIG. 3 is a perspective view showing an antenna housing of the mobile phone shown in FIG. 1.

FIG. 4 is a perspective view showing the antenna housing within the region surrounded by chain double-dashed line IV shown in FIG. 3.

FIG. 5 is a perspective view showing the state in which the antenna element has been removed from the antenna housing shown in FIG. 4. FIG. 6 is a cross-sectional view showing the antenna housing along line VI-VI shown in FIG. 4.

FIG. 7 is a perspective view showing the antenna housing of a mobile phone according to a second embodiment of this invention.

FIG. 8 is a perspective view showing the antenna housing within the region surrounded by chain double-dashed line VIII shown in FIG. 7.

FIG. 9 is a cross-sectional view showing a mobile phone according to a third embodiment of this invention.

FIG. 10 is a cross-sectional view showing a modification of the mobile phone shown in FIG. 9.

### DESCRIPTION OF EMBODIMENTS

Embodiments of this invention will be described with reference to the drawings, in which the same or corresponding elements are labeled with the same numerals.

### First Embodiment

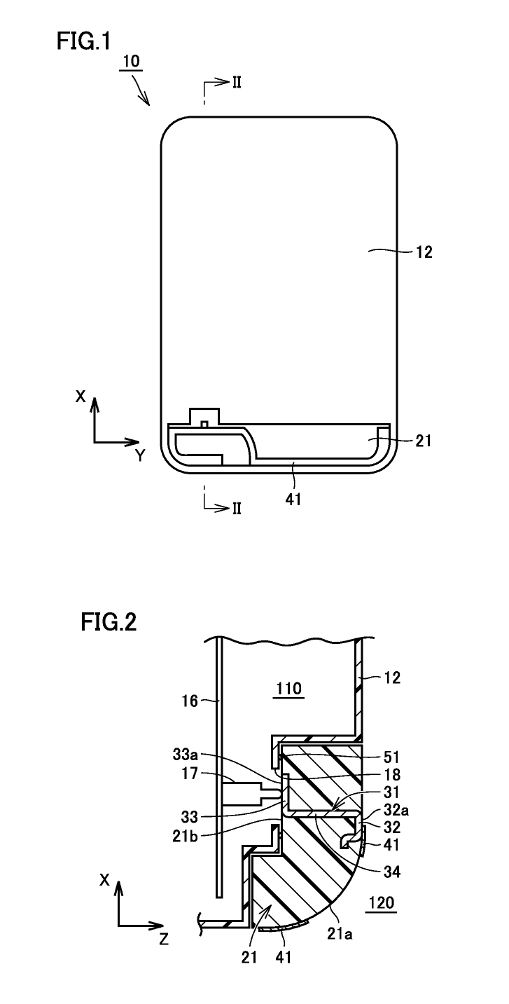

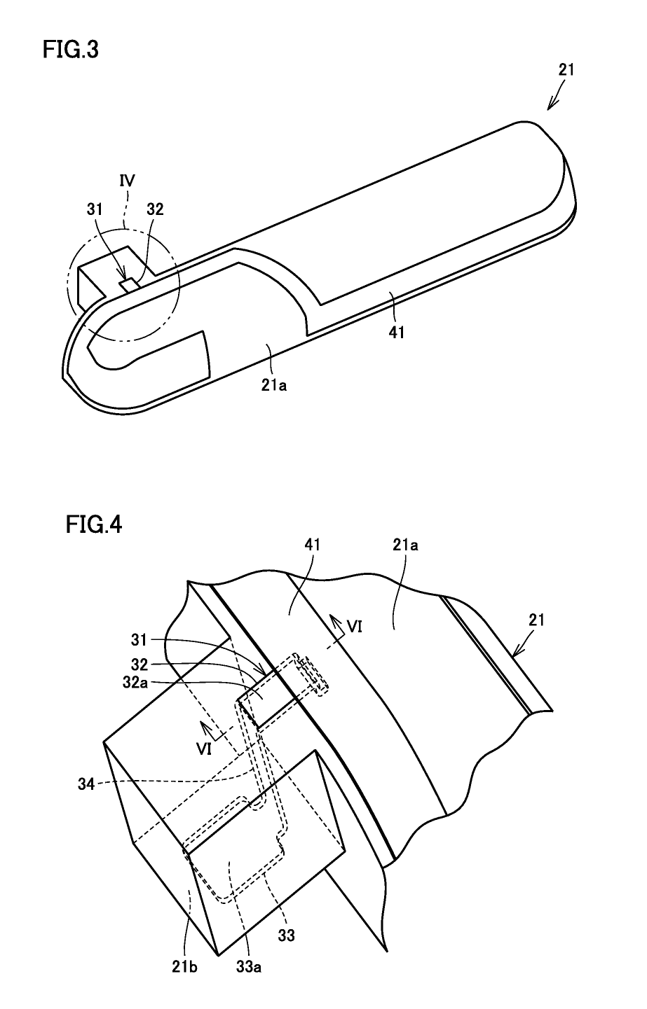

FIG. 1 is a front view showing the appearance of a mobile phone according to a first embodiment of this invention. FIG. 2 is a cross-sectional view showing the mobile phone along line 11-11 shown in FIG. 1. FIG. 3 is a perspective view showing an antenna housing of the mobile phone shown in FIG. 1.

With reference to FIGS. 1 to 3, a mobile phone 10 in this embodiment is a multifunctional type mobile phone having, in addition to a telephone function and a communication function, various functions such as an Internet function and the like. Mobile phone 10 includes, as its principal elements, a main body case 12, an antenna housing 21, a substrate 16, an insert metal plate 31, an antenna element 41, and packing 51.

Main body case 12 forms the appearance of mobile phone 10. Main body case 12 has a flat plate shape in which directions along an X axis, a Y axis, and a Z axis, respectively, shown in the figures are defined as a longitudinal direction, a lateral (width) direction, and a thickness direction. Substrate 16 is housed within main body case 12. Main body case 12 houses, in addition to substrate 16, a plurality of electronic components for mobile phone 10 to perform its functions. On an outer surface of main body case 12, a display on which various screens are displayed is provided, although not shown.

A mounted spring 17 is mounted on substrate 16. Mounted spring 17 electrically connects between substrate 16 and insert metal plate 31, which is described below. An opening 18 is formed in main body case 12. Opening 18 is formed to provide communication between space within main body case 12 that houses substrate 16 and space outside main body case 12. Opening 18 is provided in a position opposed to mounted spring 17. In this embodiment, opening 18 is provided such that its open surface faces the Z axis direction (the thickness direction of main body case 12).

Antenna housing 21, together with main body case 12, forms the appearance of mobile phone 10. Antenna housing 21 is formed of a resin. Antenna housing 21 is smaller than main body case 12.

Antenna housing 21 is combined with an end of main body case 12 in the X axis direction (longitudinal direction). Antenna housing 21 is combined with the bottom of main body case 12. Antenna housing 21 is combined with main body case 12 so as to block opening 18. Antenna housing 21 as a whole has a bar shape extending in the Y axis direction (the width direction of main body case 12).

Antenna housing 21 has an outer surface 21a and a mating surface 21b. Outer surface 21a faces outside space, and forms the appearance of mobile phone 10. Outer surface 21a is formed to include a curved surface. Mating surface 21b is provided to face main body case 12. In this embodiment, mating surface 21b faces main body case 12 around opening 18. Mating surface 21b extends on a X axis-Y axis plane.

Antenna element 41 has an antenna function for communication. Antenna element 41 has a thin film shape, and is provided on outer surface 21a of antenna housing 21. Antenna element 41 is provided along the curved shape of outer surface 21a of antenna housing 21. Antenna element 41 as a whole extends in the Y axis direction (the width direction of main body case 12) as it changes its direction of travel more than once. Antenna element 41 has a thickness not less than 10 μm and not more than 100 μm, for example.

In this embodiment, antenna element 41 is formed by printing a conductive metal pattern on outer surface 21a of antenna housing 21. Antenna element 41, however, is not limited to such a structure, and may also be formed with metal plating, for example. Antenna element 41 may be obtained by forming an element into a prescribed antenna shape directly onto outer surface 21a of antenna housing 21. Alternatively, antenna element 41 may be obtained by joining onto outer surface 21a of antenna housing 21 an element formed into a prescribed antenna shape.

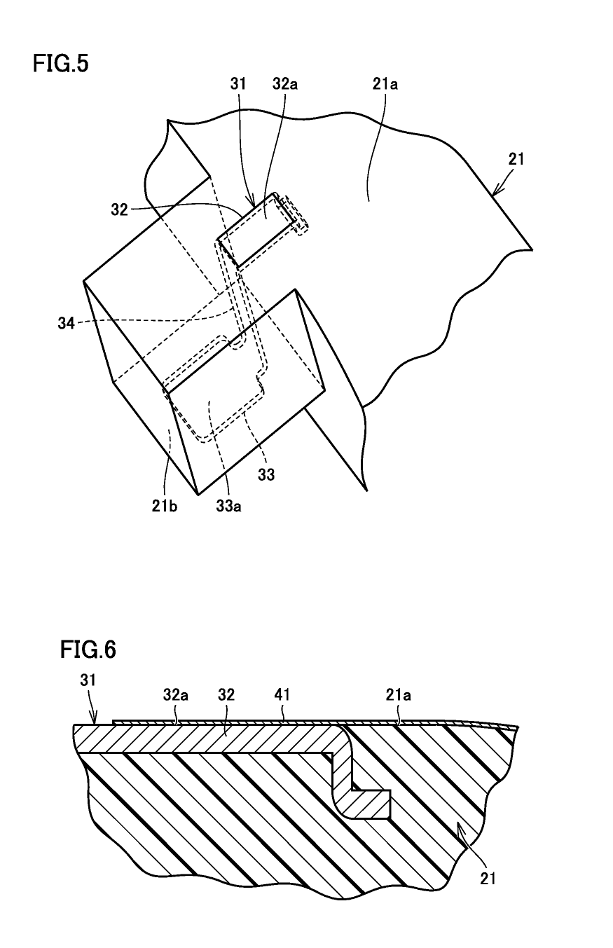

FIG. 4 is a perspective view showing the antenna housing within the region surrounded by chain double-dashed line IV shown in FIG. 3. FIG. 5 is a perspective view showing the state in which the antenna element has been removed from the antenna housing shown in FIG. 4. FIG. 6 is a cross-sectional view showing the antenna housing along line VI-VI shown in FIG. 4.

With reference to FIGS. 2 to 6, insert metal plate 31 is formed of a conductive member. Insert metal plate 31 is provided as a conductive member for electrically connecting between substrate 16 and antenna element 41. Insert metal plate 31 is insert molded into antenna housing 21 made of a resin. Insert metal plate 31 is buried in antenna housing 21 by insertion molding.

With respect to the shape of insert metal plate 31, specifically, insert metal plate 31 has, as its constitutional parts, a connecting portion 32, a power feed portion 33, and an intermediate portion 34.

Connecting portion 32 is provided to become exposed to the outside space from outer surface 21a of antenna housing 21. Power feed portion 33 is provided to become exposed within main body case 12. Power feed portion 33 is exposed within main body case 12 through opening 18. Intermediate portion 34 is provided to connect between connecting portion 32 and power feed portion 33. Insert metal plate 31 is covered with the resin that forms antenna housing 21, between connecting portion 32 and power feed portion 33 (that is, on intermediate portion 34).

In this embodiment, insert metal plate 31 has a shape bent at a right angle between connecting portion 32 and intermediate portion 34 and between intermediate portion 34 and power feed portion 33. Insert metal plate 31 as a whole has a Z-shaped cross section. The shape of insert metal plate 31 may be changed as appropriate, in correspondence with the positional relation between substrate 16 (mounted spring 17) and antenna element 41.

Connecting portion 32 has a surface 32a. Surface 32a is exposed to the outside space from outer surface 21a of antenna housing 21. Surface 32a extends from outer surface 21a of antenna housing 21 in a continuously connected manner That is, surface 32a of connecting portion 32 is provided to become even with outer surface 21a of antenna housing 21. Surface 32a of connecting portion 32 is flush with outer surface 21a of antenna housing 21.

Power feed portion 33 has a surface 33a. In this embodiment, surface 33a is exposed within main body case 12 from mating surface 21b of antenna housing 21. Surface 33a extends from mating surface 21b of antenna housing 21 in a continuously connected manner. That is, surface 33a of power feed portion 33 is provided to become even with mating surface 21b of antenna housing 21. Surface 33a of power feed portion 33 is flush with mating surface 21b of antenna housing 21.

It is noted that structures other than the above are also possible. As long as surface 32a of connecting portion 32 is exposed to the outside space, it may be provided in a depressed or protruding position from outer surface 21a of antenna housing 21, and as long as surface 33a of power feed portion 33 is exposed within main body case 12, it may be provided in a depressed or protruding position from mating surface 21b of antenna housing 21. Antenna element 41 is provided on outer surface 21a of antenna housing 21 to be in contact with connecting portion 32. Antenna element 41 is in contact with surface 32a of connecting portion 32. Mounted spring 17 is provided to be in contact with power feed portion 33. Mounted spring 17 is biased toward power feed portion 33 due to its elastic force. With this structure, substrate 16 and antenna element 41 are electrically connected with each other with insert metal plate 31 and mounted spring 17 interposed therebetween, inside and outside main body case 12.

Packing 51 is provided as a seal member that establishes waterproofness between main body case 12 and antenna housing 21. Packing 51 is held between main body case 12 and antenna housing 21. Packing 51 is provided in contact with mating surface 21b. Packing 51 is provided to surround the circumference of opening 18.

Packing 51 serves to define a boundary between a waterproof region 110, which is space in which substrate 16 and various electronic components are housed, and a non-waterproof region 120, which is space outside waterproof region 110 and in which antenna element 41 is disposed. Packing 51 is provided so as not to overlap with connecting portion 32 of insert metal plate 31 and power feed portion 33. Connecting portion 32 of insert metal plate 31, serving as a contact point with antenna element 41, is disposed in non-waterproof region 120. Power feed portion 33 of insert metal plate 31, serving as a contact point with substrate 16, with mounted spring 17 interposed therebetween, is disposed in waterproof region 110.

In mobile phone 10 according to this embodiment, since insert metal plate 31 for electrically connecting between substrate 16 and antenna element 41 is insert molded into antenna housing 21, the waterproofness of mobile phone 10 can be prevented from being impaired due to the connection structure between substrate 16 and antenna element 41. In particular, in this embodiment, packing 51 for establishing the waterproofness between main body case 12 and antenna housing 21 is provided so as not to overlap with power feed portion 33 and connecting portion 32 of insert metal plate 31 exposed from antenna housing 21. In this way, since unevenness due to insert metal plate 31 is not formed on the region where packing 51 is provided, the waterproofness of mobile phone 10 can be sufficiently improved.

Additionally, during the manufacturing process of mobile phone 10, antenna housing 21 into which insert metal plate 31 has been insert molded in advance is assembled onto main body case 12, thus completing the electrical connection between substrate 16 and antenna element 41. This allows the manufacturing process of mobile phone 10 to be simplified.

With respect to the structure of mobile phone 10 according to the first embodiment of this invention described above, in summary, mobile phone 10 as a mobile device according to this embodiment includes antenna housing 21 as a housing made of a resin, insert metal plate 31 as a conductive member being insert molded into antenna housing 21 and having connecting portion 32 exposed from outer surface 21a of antenna housing 21, and thin film-shaped antenna element 41 being provided on outer surface 21a of antenna housing 21 and brought into contact with connecting portion 32.

In mobile phone 10 according to the first embodiment of this invention having the above-described structure, since insert metal plate 31 for electrically connecting between substrate 16 and antenna element 41 is insert molded into antenna housing 21, sufficient waterproofness of mobile phone 10 can be ensured with a simple structure.

While the case in which the invention is applied to a mobile phone has been described in this embodiment, the invention is not limited thereto, and is applied to any of various types of mobile devices having an antenna outside the housing.

### Second Embodiment

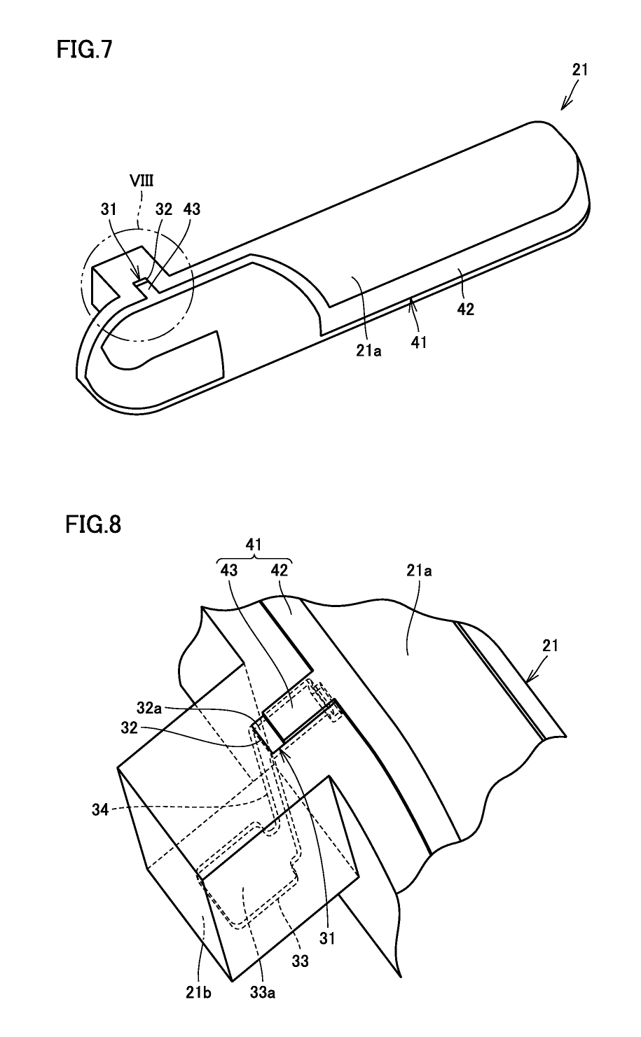

FIG. 7 is a perspective view showing the antenna housing of a mobile phone according to a second embodiment of this invention. FIG. 8 is a perspective view showing the antenna housing within the region surrounded by chain double-dashed line VIII shown in FIG. 7. FIGS. 7 and 8 correspond to FIGS. 3 and 4, respectively, in the first embodiment. The mobile phone according to this embodiment is basically similar in structure to mobile phone 10 according to the first embodiment. The description of the same parts of the structure will not be repeated below.

With reference to FIGS. 7 and 8, in this embodiment, antenna element 41 has, as its constitutional parts, an antenna element main body 42 and an extension 43.

Antenna element main body 42 extends on outer surface 21a of antenna housing 21. Antenna element main body 42 as a whole extends in the Y axis direction (the width direction of main body case 12) as it changes its direction of travel more than once. Antenna element main body 42 extends in the form of a string on outer surface 21a of antenna housing 21.

Extension 43 is provided as a branch from the path of antenna element main body 42. Extension 43 extends toward connecting portion 32 from the path of antenna element main body 42 to be brought into contact with connecting portion 32 of insert metal plate 31 at its end.

The mobile phone according to the second embodiment of this invention having the above-described structure can provide an effect similar to that described in the first embodiment.

Additionally, the provision of extension 43 in antenna element 41 allows the shape of antenna element main body 42 to be determined without taking into account the connected position with insert metal plate 31. This allows a connection between antenna element 41 and insert metal plate 31 to be established by means of extension 43, while achieving an efficient antenna shape in antenna element main body 42.

### Third Embodiment

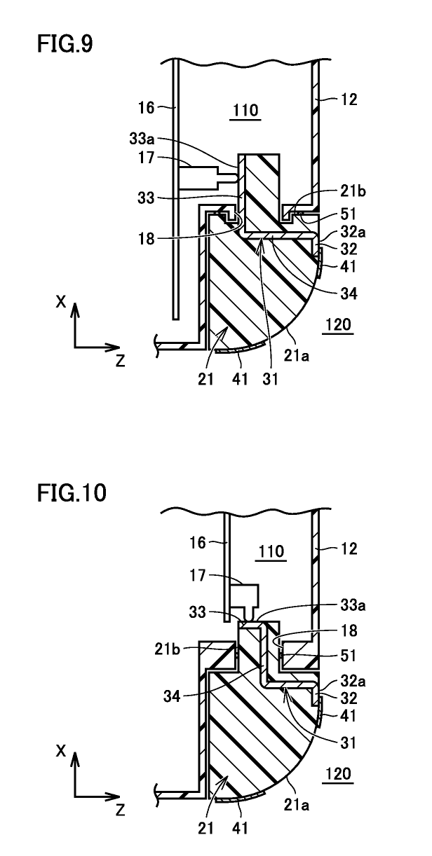

FIG. 9 is a cross-sectional view showing the appearance of a mobile phone according to a third embodiment of this invention. FIG. 9 corresponds to FIG. 2 in the first embodiment. The mobile phone according to this embodiment is basically similar in structure to mobile phone 10 according to the first embodiment. The description of the same parts of the structure will not be repeated below.

With reference to FIG. 9, in this embodiment, opening 18 formed in main body case 12 is provided such that its open surface faces the X axis direction (the longitudinal direction of main body case 12). Antenna housing 21 is combined with the bottom of main body case 12 such that it is partially inserted into main body case 12 through opening 18 in the X axis direction.

Power feed portion 33 of insert metal plate 31 is exposed within main body case 12 in a position facing substrate 16. Mating surface 21b of antenna housing 21 is provided to face main body case 12. Mating surface 21b faces main body case 12 around opening 18. Mating surface 21b extends on a Y axis-Z axis plane. Packing 51 is provided in contact with mating surface 21b. Packing 51 is provided to surround the circumference of opening 18.

FIG. 10 is a cross-sectional view showing a modification of the mobile phone shown in FIG. 9. With reference to FIG. 10, in this modification, power feed portion 33 of insert metal plate 31 is exposed within main body case 12 in a position facing mounted spring 17 in the X axis direction. Mating surface 21b of antenna housing 21 is provided to face main body case 12. Mating surface 21b faces an inner circumferential surface of main body case 12 that defines opening 18. Packing 51 is provided in contact with mating surface 21b. Packing 51 is provided along the inner circumferential surface of main body case 12 that defines opening 18.

The mobile phone according to the third embodiment of this invention having the above-described structure can provide an effect similar to that described in the first embodiment.

It is noted that the structures of the mobile phones described in the first to third embodiments may be combined as appropriate to constitute a new mobile phone. For example, the mobile phone according to the third embodiment may be combined with antenna element 41 including antenna element main body 42 and extension 43 according to the second embodiment.

Preferred embodiments of the invention will be described hereinafter in correspondence with the mobile phones in the embodiments.

Preferably, a mobile phone as a mobile device further includes main body case 12 that is combined with antenna housing 21 as a housing and houses substrate 16, and packing 51 as a seal member that is provided between main body case 12 and antenna housing 21 as a housing, and defines a boundary between waterproof region 110 in which substrate 16 is disposed and non-waterproof region 120 in which antenna element 41 is disposed. Insert metal plate 31 as a conductive member further has power feed portion 33 exposed within main body case 12 and electrically connected to substrate 16. Packing 51 as a seal member is provided so as not to overlap with connecting portion 32 and power feed portion 33.

More preferably, antenna element 41 has antenna element main body 42 that extends on outer surface 21a of antenna housing 21 as a housing, and extension 43 that extends toward connecting portion 32 from the path of antenna element main body 42 to be brought into contact with connecting portion 32 at its end.

More preferably, connecting portion 32 includes surface 32a that extends from outer surface 21a of antenna housing 21 as a housing in a continuously connected manner

More preferably, antenna element 41 is brought into surface contact with connecting portion 32.

It should be understood that the embodiments disclosed herein are illustrative and non-restrictive in every respect. It is intended that the scope of the present invention is defined by the terms of the claims rather than by the foregoing description, and includes all modifications within the scope and meaning equivalent to the claims.

### INDUSTRIAL APPLICABILITY

This invention is applied to mobile devices such as mobile phones.

### REFERENCE SIGNS LIST

10: mobile phone; 12: main body case; 16: substrate; 17: mounted spring; 18: opening; 21: antenna housing; 21a: outer surface; 21b: mating surface; 31: insert metal plate; 32: connecting portion; 32a, 33a: surface; 33: power feed portion; 34:

intermediate portion; 41: antenna element; 42: antenna element main body; 43: extension; 51: packing; 110: waterproof region; 120: non-waterproof region.

1. A mobile device comprising:
a housing made of a resin;
a conductive member being insert molded into said housing and having a connecting portion exposed from an outer surface of said housing; and
a thin film-shaped antenna element being provided on the outer surface of said housing and brought into contact with said connecting portion.

2. The mobile device according to claim 1, further comprising:
a main body case combined with said housing and housing a substrate; and
a seal member provided between said main body case and said housing, said seal member defining a boundary between a waterproof region in which said substrate is disposed and a non-waterproof region in which said antenna element is disposed, wherein
said conductive member further has a power feed portion exposed within said main body case and electrically connected to said substrate, and
said seal member is provided so as not to overlap with said connecting portion and said power feed portion.

3. The mobile device according to claim 1, wherein
said antenna element has an antenna element main body extending on the outer surface of said housing, and an extension extending toward said connecting portion from a path of said antenna element main body to be brought into contact with said connecting portion at an end thereof.

4. The mobile device according to claim 1, wherein
said connecting portion includes a surface extending from the outer surface of said housing in a continuously connected manner.

5. The mobile device according to claim 1, wherein
said antenna element is brought into surface contact with said connecting portion.
